(19) United States
(12) Patent Application Publication
(10) Pub. No.: US 2023/0286249 A1
(43) Pub. Date: Sep. 14, 2023

(54) LAMINATES WITH OPTICAL LAYERS OR MATERIALS

(71) Applicant: DelStar Technologies, Inc., Middletown, DE (US)

(72) Inventor: Thomas Burke, Middletown, DE (US)

(21) Appl. No.: 18/016,950

(22) PCT Filed: Jul. 2, 2021
(86) PCT No.: PCT/US2021/040300

§ 371 Date: Jan. 19, 2023

Related U.S. Application Data
(60) Provisional application No. 63/054,092, filed on Jul. 20, 2020.

(51) Int. Cl. B32B 7/023; B32B 27/06; B32B 27/40

(52) U.S. Cl. CPC B32B 7/023; B32B 27/06; B32B 27/40; B32B 2250/03; B32B 2250/40; B32B 2307/4026; B32B 2307/416

(57) ABSTRACT

Provided are laminates, films and/or composites made from thermoplastic polymers, such as thermoplastic polyurethane (TPU). The laminates have one or more optical layers made from materials that allow the transmission of visible light and reflect or absorb UV and/or IR light. Laminates of the present invention are less susceptible to moisture wicking into the TPU layers, providing a more durable laminate and improving the quality of visible light passing therethrough. Glass composites, such as window glass, are also provided that include TPU and the optical materials therein.

### CROSS-REFERENCE TO RELATED APPLICATIONS

This application claims the benefit of U.S. Provisional Application Ser. No. 63/054,092, filed Jul. 20, 2020, the entire disclosure of which is incorporated herein by reference for all purposes.

### BACKGROUND OF THE INVENTION

This disclosure relates to composites, films and/or laminates comprising thermoplastic polymers and one or more optical materials or layers that block UV and/or IR radiation while being substantially transparent to visible light.

Film and laminates having high optical transparency to visible light are desirable in a number of applications. For example, films having high optical transparency are used in vehicle windshields and sunroofs, food packaging, optical disk devices, residential and commercial windows and the like.

Solar radiation is radiant (electromagnetic) energy from the sun. It provides light and heat for the Earth and energy for photosynthesis. This radiant energy is necessary for the metabolism of the environment and its inhabitants. The solar radiation spectrum is divided into different radiation regions defined by the wavelength range. In general, human eyes are capable of sensing visible lights with wavelengths in the range of about 400 nm to 700 nm. Invisible light comprises infrared rays with wavelengths of about 700 nm to 1 m and ultraviolet rays with wavelengths of about 10 nm to 400 nm.

The various radiation regions of the solar spectrum can impose different effects on the environment and humans. Although small amounts of UV light can be beneficial for humans, prolonged exposure to UV radiation can damage human skin and lead to acute and chronic health issues. Similarly, prolonged exposure to UV light can also damage or tarnish goods, such as upholstery and furniture. Although radiation in the visible region provides natural light, prolonged exposure to IR radiation can heat up an object. Infrared rays further include light rays whose wavelength is near that of visible light, which are called near-infrared rays (i.e., wavelengths of about 700 nm to about 1200 nm). Near-infrared rays are also called thermic rays, which are one cause of temperature increases inside vehicles and buildings. Infrared rays have no effects on the color vision of human beings, but do have effects on photographic devices such as video cameras, cameras, or mobile phone cameras.

Thus, while solar radiation brings natural lighting to a building or an automobile interior through windows, it also brings along unwanted effects from UV and IR radiation. UV radiation causes direct harm and damage to objects in the interior of a space; while IR radiation raises the interior temperature, thereby requiring large amounts of electricity to be consumed by air-conditioners to maintain a comfortable interior temperature in hot weather. As such, a functional window that transmits visible light but blocks UV and near IR light is essential for buildings and automobiles to reduce the electricity load and to protect all objects and users inside.

Laminated glass windows with polymeric interlayers are commonly employed for safety concerns and improved energy efficiency, with polyvinyl butyral (PVB) resin sheets being the most common glass laminate. Conventional automotive or architectural glazing or window structures often include a laminate typically made of two rigid glass or plastic sheets and an interlayer of plasticized polyvinyl butyral (PVB). PVB sheets are commonly used because they can hold sharp glass fragments in place when the glass is broken. Thus, PVB laminated safety glass is widely applied in building and automobile windows, show cases, and other places where human interactions are highly involved.

An optical filter is a device that selectively transmits and/or blocks light of different wavelengths. The optical properties of filters are completely described by their frequency response, which specifies how the magnitude and phase of each frequency component of an incoming signal is modified by the filter. Optical layers or filters can be disposed within, or between, PVB sheets to block UV and/or IR light passing through the laminated window.

PVB layers, however, have certain drawbacks in laminates, such as glass windows. For example, a high level of moisture can wick into the PVB layers during use. This moisture can ultimately cause failure of the laminate or reduce the quality of visible light passing through the window. In addition, PVB generally has a high modulus and a low tensile strength, which can negatively impact the performance of the glazing in such applications as windows and automobile windshields. Moreover, PVB interlayers can bleed between the film layers at edges and cause enough separation to create highly colored iridescence called “edge brightening”. Edge brightening is not a desirable characteristic in glass laminates of this type.

What is needed, therefore, are improved laminates for vehicle and building windows that are more durable and less susceptible to moisture penetration and/or bleeding, while still providing protection from the adverse effects of UV and IR radiation.

### SUMMARY OF THE INVENTION

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The present disclosure relates to laminates, films and/or composites made from thermoplastic polymers, preferably thermoplastic polyurethane (TPU). The laminates have one or more optical materials and/or layers made from materials that allow the transmission of visible light and reflect or absorb UV and/or IR light. In certain embodiments, the present disclosure relates to laminates that include multiple layers of TPU and optical materials. In other embodiments, the present disclosure relates to glass composites, such as window glass, that include TPU and optical materials therein.

The laminates of the present invention are less susceptible to moisture wicking into the TPU layers, providing a more durable laminate and improving the quality of visible light passing therethrough. TPU also has desirable properties that allow it to be etched into plastics. In addition, the TPU laminates of the present disclosure are less susceptible to bleeding between the film layers at edges, thereby reducing edge brightening.

The TPU layers are preferably selected from a material that provides sufficient transparency to visible light and exhibits suitable adhesion to glass, polycarbonate, acrylyic, cellulose acetate butyrate, or other surfaces which the layers may contact. In certain embodiments, the TPU layers may have a storage modulus sufficient to substantially absorb and dissipate the kinetic energy of air particulates that contact its surface, such as rain, hail, wind, dirt and other contaminants. At the same time, the TPU material preferably has substantial tear and abrasion resistance, thereby protecting the laminate from adverse environmental conditions.

The TPU layer(s) preferably have a thickness of about 100 to 800 microns, more preferably about 300 to 500 microns. In certain embodiments, the TPU layers comprise an aliphatic thermoplastic polyurethane.

In one aspect of the invention, a laminate comprises a first thermoplastic polyurethane layer (TPU), a second TPU layer and an optical layer disposed between, and in contact with, the first and second TPU layers. The optical layer substantially allows the transmission of visible light therethrough and either reflects or absorbs IR light.

The IR blocking optical layer is configured to reflect or absorb light having a wavelength of about 700 nanometers to 1 mm, preferably between about 700 nm to about 1400 nm (i.e., near-infrared wavelengths) and more preferably between about 750 nm to about 1200 nm. In one embodiment, the optical layer comprises an IR-reflective coating. Suitable materials for reflecting light having wavelengths in the IR range include metal or metal-based coatings, such as double-layer or triple-layer silver coatings, liquid crystal materials that selectively operate to transmit or scatter IR light and the like.

In another embodiment, the optical layer comprises an IR absorbing material, such as an IR absorbing dye, copper salt compositions, such as copper phosphonate, nanoparticles (such as zinc oxide, antimony tin oxide (ATO), lanthanum hexaboride (LaB) and the like), infrared filters, such as blue glass, interlayer films comprising infrared-shielding fine particles, and the like.

In yet another embodiment, the IR absorbing material includes IR absorbing particles, such as nanoparticles, dispersed into one of the TPU layers. In this embodiment, for example, the first TPU layer may include the UV blocking material, while the second TPU layers includes the IR blocking particles.

In certain embodiments, the first TPU layer may include an optical material that can either reflect or absorb UV light. The UV blocking optical material preferably reflects or absorbs light having a wavelength between about 10 and 410 nanometers, more preferably greater than about 380 nanometers and even more preferably between about 380 and 410 nanometers. The optical material may comprise any suitable material configured to reflect or absorb UV light, such as UV radiation absorbing, blocking or screening additives. UV radiation absorbing, blocking or screening additives suitable for the present disclosure include bezophenones, cinnamic acid derivatives, esters of benzoin acids, alicylic acid, terephthalic and iosphtalic acids with resorcinol and phenols, pentamethyl piperidine derivatives, salicylates, benzotriazoles, cyanoacrylates, benzylidenes, malonates and oxalanilides combined with nickel chelates and hindered amines.

Alternatively, UV blocking optical material may comprise a light filtering layer within the TPU layer. Suitable optical layers for use with the present invention include sheet polarizers, dichroic, reflective filter material to provide wide band UV radiation reduction and the like. For example, blue or green tinted glass with greatly reduced transmission in the UV portion or blue or green tinted polymeric interlayers, coatings or layers of UV radiation reducing paint or lacquer or polymeric films may be suitable as the UV blocking material.

In certain embodiments, the thermoplastic polyurethane layer comprises a resin that includes the UV blocking optical material. In an exemplary embodiment, the optical material comprises a first UV absorber of the benzotriazole-family and a light stabilizer. In some embodiments, the optical material may comprise a second UV absorber selected from a group consisting of benzotriazoles or benzophenones.

In certain embodiments, the optical layer comprises an IR blocker layer that can either reflect or absorb IR light and a separate UV blocker layer that can either reflect or absorb UV light. The IR blocker layer is preferably disposed between, and in contact with, the UV blocker layer and one of the first and second thermoplastic polyurethane layers. The IR blocker layer can either reflect or absorb light having wavelengths between about 700 nanometers and about 1 mm, preferably between about 700 to about 1400 nanometers, more preferably between about 750 to about 1200 nanometers. The UV block layer preferably can either reflect or absorb light having wavelengths between about 10 and 410 nanometers, preferably between about 380 and 410 nanometers.

Alternatively, the optical layer may comprise a single material that blocks both UV and IR light. Suitable materials for the optical layer in this embodiment may comprise metal coatings, such as double or triple silver layers, and the like.

In another aspect of the invention, a laminate comprises first and second TPU layers and an optical layer disposed between, and in contact with, the first and second TPU layers. The optical layer is configured to block IR light and to block UV light.

In one embodiment, the optical layer comprises an IR blocker layer that can either reflect or absorb IR light and a separate UV blocker layer that can either reflect or absorb UV light. The IR blocker layer is preferably disposed between, and in contact with, the UV blocker layer and one of the first and second thermoplastic polyurethane layers. The IR blocker layer can either reflect or absorb light having wavelengths between about 700 nanometers and about 1 mm, preferably between about 700 to about 1400 nanometers, more preferably between about 750 to about 1200 nanometers. The UV block layer preferably can either reflect or absorb light having wavelengths between about 10 and 410 nanometers, preferably between about 380 and 410 nanometers.

In another embodiment, the optical layer comprises a single material that blocks both UV and IR light. Suitable materials for the optical layer in this embodiment may comprise metal coatings, such as double or triple silver layers, and the like.

In another aspect of the invention, a laminate comprises first and second TPU layers and an optical layer disposed between, and in contact with, the first and second TPU layers. The optical layer can either reflect or absorb UV light.

In certain embodiments, at least one of the first and second TPU layers preferably comprise an aliphatic thermoplastic polyurethane resin. The optical layer preferably either reflects or absorbs light having a wavelength between about 380 and 410 nanometers. The optical layer may comprise multiple layers of UV absorbers. The optical layer may further include a light stabilizer. In an exemplary embodiment, the optical layer includes a first UV absorber of the Benzotriazole-family, a light stabilizer and a second UV absorber selected from a group consisting of benzotriazoles or benzophenones.

In another aspect of the invention, a composite comprises first and second layers of glass and a film or laminate between the first layer and the second layer of glass. The film comprises first and second TPU layers and at least one optical material within, or between, the TPU layers. The optical material can either reflect or absorb UV light. In certain embodiments, a window is provided that includes the composite.

In one embodiment, the optical material is disposed within the first TPU layer and comprises a material that blocks UV light. The film further comprises an optical layer disposed between, and in contact with, the first and second TPU layers that can block IR light.

In another embodiment, the film comprises first and second TPU layers and an optical layer disposed between, and in contact with, the first and second TPU layers. The optical layer comprises an IR blocker layer that can either reflect or absorb IR light and a UV blocker layer that can either reflect or absorb UV light. The UV blocker layer is preferably disposed between, and in contact with, the IR blocker layer and one of the first and second thermoplastic polyurethane layers.

In another embodiment, the film comprises first and second TPU layers and an optical layer disposed between, and in contact with, the first and second thermoplastic polyurethane layers. The optical layer can either reflect or absorb UV light.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

FIG. 1 is a cross-sectional view of one embodiment of an optical film or laminate according to the present disclosure;

FIG. 2 is a cross-sectional view of another embodiment of an optical film or laminate according to the present disclosure;

FIG. 3 is a cross-sectional view of another embodiment of an optical film or laminate according to the present disclosure; and

FIG. 4 is a cross-sectional view of a composite glass including one of the optical laminates of the present disclosure.

### DETAILED DESCRIPTION OF THE EMBODIMENTS

This description and the accompanying drawings illustrate exemplary embodiments and should not be taken as limiting, with the claims defining the scope of the present disclosure, including equivalents. Various mechanical, compositional, structural, and operational changes may be made without departing from the scope of this description and the claims, including equivalents. In some instances, well-known structures and techniques have not been shown or described in detail so as not to obscure the disclosure. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting. Any molecular weight or molecular mass values are approximate and are provided only for description.

While the following disclosure is presented with respect to laminates and composites for glass in vehicles and buildings, it should be understood that devices and methods of the invention may be readily adapted for use in a variety of other applications, such as image sensors, electronic display screens for computers and mobile devices, food packaging, optical disk devices, appliances and the like.

Referring now to FIG. 1, a laminate 10 according to the present disclosure includes first and second polymer layers 12, 14. “Laminate” as used herein refers to structures having one or more substrates with interlayers disposed between the substrates and attached to a substrate. The polymer layers 12. 14 comprise a thermoplastic polymer, such as polyurethane. Thermoplastic Polyurethane or TPU is sometimes referred to as the bridge between rubbers and plastics. The material appears rubber-like, which means it can be extremely flexible, durable and smooth to the touch. All these properties and compound versatility makes TPU widely used in many industries for coatings, components, and laminates. The TPU may be shaped and sized to conform to a surface to be protected before application to the surface.

The thermoplastic polyurethane of the present invention will preferably comprise a material that provides sufficient transparency to visible light and exhibits suitable adhesion to glass, polycarbonate, acrylyic, cellulose acetate butyrate, or other surfaces which the films may contact. In preferred embodiments, the TPU material will exhibit abrasion resistance, heat resistance, and hardness to adverse weather elements for a long period of time. In addition, the material may have a storage modulus sufficient to substantially absorb and dissipate the kinetic energy of air particulates that contact its surface. The TPU layer(s) preferably have a thickness of about 100 to 800 microns, more preferably about 300 to 500 microns/. In certain embodiments, the thermoplastic polyurethane is a material with high energy storage modulus properties and a relatively low durometer, preferably in the range of about 60-80A, more preferably about 70-75A.

The TPU of the present invention preferably comprises an aliphatic thermoplastic polyurethane. Of course, it should be recognized by those skilled in the art that other polymer materials can be used with the present invention. For example, the polyurethane material may be a suitable aliphatic polyester or polycaprolactone. Alternatively, a thermoset polymer that is irreversibly hardened by curing from a soft solid or viscous liquid prepolymer may be used in combination with the thermoplastic polymer.

In certain embodiments, first thermoplastic polyurethane (TPU) layer 12 may include an optical material disposed within layer 12 that can either reflect or absorb UV light. The optical material preferably reflects or absorbs light having a wavelength between about 10 nanometers and 410 nanometers, preferably greater than about 380 nanometers and even more preferably between about 380 and 410 nanometers. In certain embodiments, the optical material may include two or more different materials disposed within TPU layer 12 that reflect or absorb UV light within different ranges of wavelengths within the UV spectrum. For example, the optical material may include one material that reflects or absorbs UV light having wavelengths in a range of about 300 to 380 nanometers and another material that substantially reflects or absorbs UV light having wavelengths in the range of about 380 to 410 nanometers. Other similar configurations can be envisioned by those skilled in the art.

The optical material may comprise any suitable material configured to block UV light, such as UV radiation absorbing, blocking or screening additives, stabilizers and the like. UV radiation absorbing, blocking or screening additives suitable for the present disclosure include bezophenones, cinnamic acid derivatives, esters of benzoin acids, alicylic acid, terephthalic and iosphtalic acids with resorcinol and phenols, pentamethyl piperidine derivatives, salicylates, benzotriazoles, cyanoacrylates, benzylidenes, malonates and oxalanilides. These additives may be combined with each other or with other materials, such as nickel chelates and hindered amines.

Alternatively, optical material may comprise a separate light filtering layer with TPU layer 12. Suitable optical layers for use with the present invention include sheet polarizers, dichroic, reflective filter material to provide wide band UV radiation reduction and the like. For example, blue or green tinted glass with greatly reduced transmission in the UV portion or blue or green tinted polymeric interlayers, coatings or layers of UV radiation reducing paint or lacquer or polymeric films may be suitable for the optical material.

The optical material is preferably capable of blocking about 95% of light having a wavelength ranging from about 380 nm to about 410 nm. The Yellowness Index (YI) value of the optical material is preferably less than or equal to 3.0 and more preferably less than or equal to 2.5.

In certain embodiments, one of more of TPU layers 12, 14 may comprise a resin composition that includes the optical material therein. TPU resin compositions in accordance with this disclosure may include any aliphatic polyether-based TPU that provides sufficient transparency and may exhibit suitable adhesion to glass, polycarbonate, acrylyic, cellulose acetate butyrate, or other surfaces which the films may contact. In certain embodiments, suitable TPU resins may be polyether-based and made from methylene diphenyl diisocayanate (MDI), polyether polyol, and butanediol. In an exemplary embodiment, the TPU resin may be Estane AG-8451 Resin sold by Lubrizol. In embodiments the TPU resin may be present in the resin composition in an amount from about 95 to about 99.99% by weight; preferably from about 98 to about 99.99% by weight, and more preferably from about 99.5% to about 99.99%

TPU resin compositions in accordance with this disclosure may include a first UV absorber. In exemplary embodiments, the first UV absorber may be any suitable UV absorber made from compounds in the benzotriazole family.

TPU resin compositions in accordance with this disclosure also include a light stabilizer. Suitable light stabilizers primarily protect the polymers of the optical film from the adverse effects of photo-oxidation caused by exposure to UV radiation. In embodiments, the light stabilizer may serve a secondary function of acting as a thermal stabilizer, for low to moderate levels of heat. In embodiments, suitable light stabilizers may be derivatives of tetramethylpiperidine. In embodiments, the light stabilizer may be any suitable hindered amine light stabilizer (HALS).

In certain embodiments, the TPU resin composition includes a first UV absorber, a light stabilizer, and a second UV absorber. The films made from such TPU resin compositions have desirable optical characteristics provided by the combination of UV absorbers. A more complete description of a suitable resin composition for TPU layer 12 can be found in commonly assigned, co-pending U.S. Provisional Application Ser. No. 62/876,171, filed Jul. 19, 2019, the complete disclosure of which is hereby incorporated by reference in its entirety for all purposes.

The resin composition may be prepared by preparing a base composition including one or more TPU resins, the first UV absorber and a light stabilizer. The base composition is combined with a concentrate containing the second UV absorber and the same or a different TPU resin. In embodiments, the base resin and concentrate are dry blended. In embodiments, the ratio of base composition to concentrate is from about 20:1 to about 3:1, in embodiments, from about 10:1 to about 7:1.

Laminate 10 further includes an IR blocking optical layer 16 disposed between, and in contact with, the first and second TPU layers 12, 14. Optical layer 16 can either reflect or absorb IR light having a wavelength of about 700 nanometers to 1 mm, preferably between about 700 nm to about 1400 nm, and more preferably between about 750 nm to about 1200 nm (i.e., near-infrared wavelengths). In one embodiment, the optical layer comprises an IR-reflective coating. Suitable materials for reflecting light having wavelengths in the IR range include metal or metal-based coatings, such as double-layer or triple-layer silver coatings, liquid crystal materials that selectively operate to transmit or scatter IR light and the like.

Optical layer 16 may comprise two or more different layers, coatings, films or other materials with each layer configured to reflect or absorb IR light in different wavelengths within the IR spectrum. For example, optical layer 16 may comprise a first IR blocker layer or material that substantially blocks IR light having wavelengths in a range of about 700 to about 900 nanometers, a second IR blocker layer or material that substantially blocks wavelengths in the range of about 900 to about 1000 nanometers and a third IR blocker layer or material that substantially blocks wavelengths in the range of about 1000 to 1400 nanometers. Other similar configurations can be envisioned by those skilled in the art.

Suitable IR blocking optical layers of the present invention may include, but are not necessarily limited to, infrared reflecting films, polarized films, non-polarized films, multi-layer films, colored or tinted films, and decorative films. Optical layer 16 may comprise an IR-reflective or IR-absorptive film such as is known and described in publications from, for example, Minnesota Manufacturing and Mining Company (3M) or Southwall Technologies, Inc..

In certain embodiments, optical layer 16 can be a metal or metal-based coating of the type that reflects IR wavelength light while transmitting visible light. The coating can be sputtered or otherwise applied to a major face of either TPU layer 12 or 14. In certain embodiments, IR reflective coatings include double-layer silver coatings. In other embodiments, IR reflective coatings include triple-layer silver coatings. In yet other embodiments, the IR reflective coating be a triple-layer silver coating that also reflects light in the UV spectrum. Such double-layer silver coatings, triple-layer silver coatings and triple-layer silver coatings with enhanced IR and UV reflection are commercially available from PGW. Other reflecting type infrared filters includes a transparent medium such as glass, acrylic (PMMA) and quartz, stainless steel or tin oxide, metal oxide, nitride, halide or sulfide films.

In another embodiment, the optical layer 16 comprises an IR absorbing material, such as an IR absorbing dye, copper salt compositions, such as copper phosphonate, nanoparticles (such as zinc oxide, antimony tin oxide (ATO), lanthanum hexaboride (LaB), copper sulfide and the like), copper deficient chalcogenide nanocrystals, indium doped zinc oxide (IZO) nanocrystals and the like. Alternatively, optical layer 16 may comprise an absorbing type infrared filters. IR absorbing filters suitable for the present invention include blue glass, interlayer films comprising infrared-shielding fine particles, fluorophosphate-based infrared filter glass or phosphate-based infrared filter glass and the like.

Optical layer 16 may include other light absorbing components in combination with any of the above materials. In certain embodiments, optical layer 16 includes other light absorbing components in combination with copper chalcogenide nanoparticles, such as oxide nanoparticles. The oxide nanoparticles, such as ITO (tin-doped indium oxide), ATO, or mixtures thereof, are dispersed in the optical layer with the copper chalcogenide nanoparticles. Further, these additional components may also be dispersed in separate polymer sheets in a multilayer laminate. Additional light reflective layers such as multi-layered silver/antireflective coatings and multi-layered polymer films can also be combined with the copper chalcogenide by coating or attaching the reflective layers to any one side of the glass substrate, or to the TPU layers.

In other embodiments, optical layer 16 may include an interlayer film having infrared-shielding fine particles of ITO, ATO or the like dispersively mixed therein or an infrared-reflective film formed from a multilayer film having a high-refractive index layer and a low-refractive index layer alternately laminated therein (dielectric multilayer film). In other embodiments, optical layer 16 may comprise a functional laminate interlayer film formed by uniformly dispersing electroconductive ultrafine particles capable of shielding infrared radiation, such as antimony-doped tin oxide (particulate film).

In alternative embodiments, optical layer 16 may comprise IR blocking particles that are dispersed within one of the TPU layers 12, 14. For example, certain nanoparticles (such as those described above) may be dispersed within the thermoplastic polymer matrix by first dissolving the TPU into a suitable solvent and adding the suspension comprising dispersed nanoparticles into the solvent. In this embodiment, the IR blocking particles may be dispersed within TPU layer 12 along with the UV blocking material, separately in TPU layer 14, or both. The nanoparticles will typically have diameters less than about 400 nm, preferably between about 5 nm to about 30 nm.

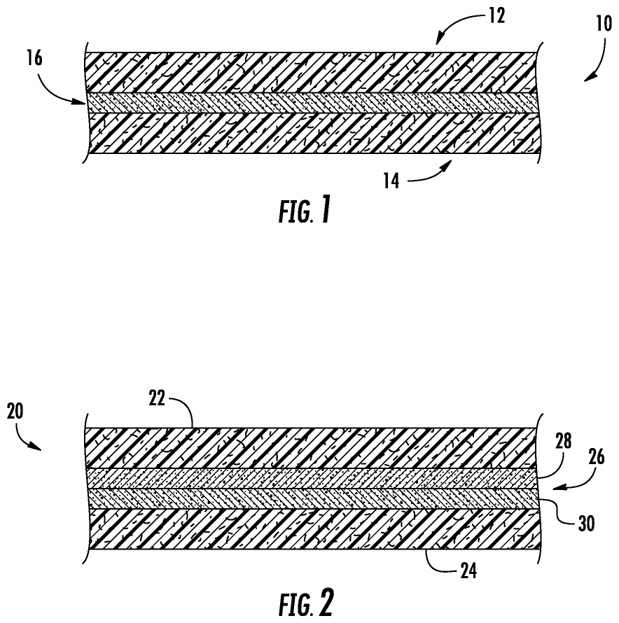

Referring now to FIG. 2, a laminate 20 according to the present invention comprises first and second TPU layers 22, 24 and an optical layer 26 disposed between, and in contact with, the first and second TPU layers 22, 24. Optical layer 26 is configured to block both IR light and UV light.

In one embodiment, optical layer 26 comprises an IR blocker layer 28 that can either reflect or absorb IR light and a UV blocker layer 30 that can either reflect or absorb UV light. UV blocker layer 30 is preferably disposed between, and in contact with, IR blocker layer 28 and one of the first and second thermoplastic polyurethane layers 22, 24. IR blocker layer 38 preferably can either reflect or absorb light having wavelengths between about 700 nanometers and about 1 mm, more preferably between about 750 to about 1200 nanometers. UV block layer 30 preferably can either reflect or absorb light having wavelengths between about 380 and 410 nanometers. IR blocker layer 28 may include any of the materials or layers described above in relation to FIG. 1. Similarly, UV blocker layer 30 may include any of the materials or layers described above.

In another embodiment, optical layer 26 comprises a single material or layer that blocks both IR and UV light. For example, optical layer 26 may comprise a double or triple layer silver coating configured to block both UV and IR wavelengths. Alternatively, optical layer 26 may comprise a multi-layered film structure that includes an IR reflecting multi-layered film and a UV reflecting multi-layered film. The optical properties of each layer within the films may have, for example, different refractive indexes and/or thicknesses, alternately laminating materials with high and low refractive indexes, for a multi-layered film structure.

Referring now to FIG. 3, a laminate 40 according to the present disclosure comprises first and second TPU layers 42, 44 and an optical layer 46 disposed between, and in contact with, the first and second thermoplastic polyurethane layers 42, 44. Optical layer 46 can either reflect or absorb UV light.

The optical material preferably reflects or absorbs light having a wavelength between about 10 nanometers and 410 nanometers, preferably greater than about 380 nanometers and even more preferably between about 380 and 410 nanometers. In certain embodiments, the optical material may include two or more different materials disposed between TPU layers 42, 44 that reflect or absorb UV light within different ranges of wavelengths within the UV spectrum. For example, the optical material may include one material that reflects or absorbs UV light having wavelengths in a range of about 300 to 380 nanometers and another material that substantially reflects or absorbs UV light having wavelengths in the range of about 380 to 410 nanometers.

Optical layer 46 may comprise any suitable material configured to reflect or absorb UV light, such as the above-described UV radiation absorbing, blocking or screening additives, stabilizers, light filters, and the like. The optical layer is preferably capable of blocking about 95% of light having a wavelength ranging from about 380 nm to about 410 nm. The Yellowness Index (YI) value of the optical material is preferably less than or equal to 3.0 and more preferably less than or equal to 2.5.

The optical films and laminates of the present invention may be prepared by a single screw cast film extrusion process, or any other suitable extrusion process within the purview of those of skill in the art.

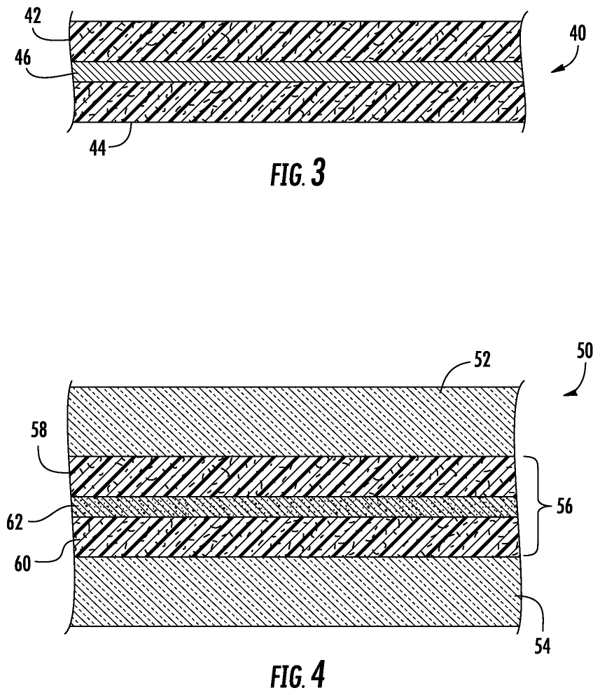

Referring now to FIG. 4, a composite 50 according to the present disclosure comprises first and second layers of glass 52, 54 and a film 56 between the first layer and the second layer of glass. Film 56 comprises first and second TPU layers 58, 60 and at least one optical material within the TPU layers 58, 60. The optical material can either reflect or absorb UV light. In certain embodiments, a window is provided that includes the composite. Film 56 may be laminated between at least two sheets of glass substrates facing each other in order to reflect light rays having particular wavelengths in the infrared region.

In one embodiment, the optical material is disposed within first TPU layer 58 and comprises a material that blocks UV light. Film 56 further comprises an optical layer (not shown) disposed between, and in contact with, the first and second TPU layers that blocks IR light.

In another embodiment, the film comprises first and second TPU layers and an optical layer disposed between, and in contact with, the first and second TPU layers. The optical layer comprises an IR blocker layer that can either reflect or absorb IR light and a UV blocker layer that can either reflect or absorb UV light. The UV blocker layer is preferably disposed between, and in contact with, the IR blocker layer and one of the first and second thermoplastic polyurethane layers.

In another embodiment, the film comprises first and second TPU layers and an optical layer disposed between, and in contact with, the first and second thermoplastic polyurethane layers. The optical layer is configured to block UV light.

Glass layers 52, 54 may comprise any clear or ultraclear glass of a type that is suitable for use in for image sensors, electronic display screens for computers and mobile devices, food packaging, optical disk devices, appliances and the like. Examples include PPG Clear glass, Solarphire.R™ glass or PPG Starphire.R™ glass. Clear glass is preferred so that when the window is illuminated with sunlight, less energy from IR light will be absorbed in glass layer 52 and more energy will be reflected back out of the outside layer of glass and away from the window. Ultraclear glass is more preferred because it absorbs less energy from IR light than clear glass and because it's higher transmittance allows more light to be reflected.

There are of course, other substantially clear materials that can be used as layers 52, 54 to provide rigidity and strength to an optical sheet. These alternative materials include polymeric materials such as, for example, acrylic, polyethylene teraphthalate (PET) or polycarbonate. A glazing component can be substantially planar or have some curvature. It can be provided in various shapes, such as a dome, conical, or other configuration, and cross-sections, with a variety of surface topographies. The present invention is not intended to necessarily be limited to the use of any particular glazing component material(s) or structure.

While the invention has been described in detail herein in accordance with certain preferred embodiments thereof, many modifications and changes therein may be effected by those skilled in the art. Accordingly, the foregoing disclosure should not be construed to be limited thereby but should be construed to include such aforementioned obvious variations and be limited only by the spirit and scope of the following claims.

What is claimed is:

1. A laminate comprising:
a first thermoplastic polyurethane layer;
a second thermoplastic polyurethane layer;
an optical layer disposed between, and in contact with, the first and second thermoplastic polyurethane layers; and
wherein the optical layer can either reflect or absorb IR light.

2. The laminate of claim 1, wherein the first and second thermoplastic polyurethane layers comprise an aliphatic thermoplastic polyurethane resin.

3. The laminate of claim 1, wherein the first thermoplastic polyurethane layer comprises an optical material that can either reflect or absorb UV light.

4. The laminate of claim 3, wherein the optical material either reflects or absorbs light having a wavelength between about 10 and 410 nanometers.

5. The laminate of claim 1, wherein the optical material either reflects or absorbs light having a wavelength greater than about 380 nanometers.

6. The laminate of claim 1, wherein the optical material either reflects or absorbs light having a wavelength between about 380 nanometers and 410 nanometers.

7. The laminate of claim 1, wherein the optical layer can either reflect or absorb light having a wavelength of about 700 nanometers to 1 mm.

8. The laminate of claim 1, wherein the optical layer can either reflect or absorb light having a wavelength of about 700 to about 1400 nm.

9. The laminate of claim 1, wherein the optical layer can either reflect or absorb light having a wavelength of about 750 to about 1200 nm.

10. The laminate of claim 3, wherein the first thermoplastic polyurethane layer comprises a thermoplastic polyurethane resin comprising the optical material.

11. The laminate of claim 10, wherein the resin comprises a UV absorber and a light stabilizer.

12. The laminate of claim 1, wherein the optical layer comprises an IR-reflective coating.

13. The laminate of claim 1, wherein the optical layer comprises an IR absorbing material.

14. The laminate of claim 1, wherein the optical layer comprises an IR absorption dye.

15. The laminate of claim 1, wherein the optical layer can either reflect or absorb UV light

16. The lamina of claim 1, wherein the optical layer comprises:
an IR blocker layer that can either reflect or absorb IR light; and
a UV blocker layer that can either reflect or absorb UV light, wherein the UV blocker layer is disposed between, and in contact with, the IR blocker layer and one of the first and second thermoplastic polyurethane layers.

17. (canceled)

18. (canceled)

19. (canceled)

20. (canceled)

21. (canceled)

22. (canceled)

23. (canceled)

24. (canceled)

25. (canceled)

26. (canceled)

27. A laminate comprising:
first and second thermoplastic polyurethane layers;
an optical layer disposed between, and in contact with, the first and second thermoplastic polyurethane layers; and
wherein the optical layer can either reflect or absorb UV light.

28. The laminate of claim 27, wherein the first and second thermoplastic polyurethane layers comprise an aliphatic thermoplastic polyurethane resin.

29. The laminate of claim 27, wherein the optical layer either reflects or absorbs light having a wavelength between about 10 nanometers to about 410 nanometers.

30. The laminate of claim 27, wherein the optical layer either reflects or absorbs light having a wavelength between about 380 nanometers to about 410 nanometers.

31. The laminate of claim 27, wherein the YI value of the optical layer is no greater than 2.5.

32. The laminate of claim 27, wherein the optical layer comprises one of a UV absorber, a UV stabilizer or a UV reflector.

33. (canceled)

34. (canceled)

35. The laminate of claim 27, wherein the optical layer can either reflect or absorb IR light.

36. The lamina of claim 27, wherein the optical layer comprises:
an IR blocker layer that can either reflect or absorb IR light; and
a UV blocker layer that can either reflect or absorb UV light, wherein the UV blocker layer is disposed between, and in contact with, the IR blocker layer and one of the first and second thermoplastic polyurethane layers.

37. (canceled)

38. (canceled)

39. (canceled)

40. (canceled)

41. (canceled)

42. (canceled)
